(19) United States
(12) Patent Application Publication
(10) Pub. No.: US 2004/0002876 A1
(43) Pub. Date: Jan. 1, 2004

(54) System, method and computer program product for on-line travel and expense management

(76) Inventors: Mark O. Sommers, Huntsville, AL (US); Linda Marler-Parker, Madison, AL (US); Albert L. Viall JR., Apple Valley, MN (US); Barbie Tarr, San Antonio, TX (US); Doris D. Cantrell, Arab, AL (US)

Correspondence Address: VENABLE, BAETJER, HOWARD AND CIVILETTI, LLP, P.O. BOX 34385, WASHINGTON, DC, 20043-9998, US

(21) Appl. No.: 10/379,822

(22) Filed: Mar. 6, 2003

Related U.S. Application Data
(60) Provisional application No. 60/361,697, filed on Mar. 6, 2002.

(51) Int. Cl. G06F 17/60

(52) U.S. Cl. 705/6

(57) ABSTRACT

An on-line travel and expense management system integrates and automates the process of arranging, changing and accounting for travel that is made for government or large corporate entities. A method in a computer system arranges travel for large corporate and government organizations. The method may include receiving a customer login at an Internet web site; authenticating the customer; receiving a selection of travel requirements from the customer; making initial travel arrangements for the customer based on the selection of travel requirements; automatically generating a travel authorization form for the customer with the initial travel arrangements; electronically forwarding the travel authorization form to an approver; notifying the customer electronically when the approver has approved the travel authorization form; notifying a travel agency of approval of the travel authorization form whereupon the travel agency confirms the initial travel arrangements; and automatically updating an accounting system electronically for the customer.

### CROSS-REFERENCE TO RELATED APPLICATIONS

This application is related to a U.S. Provisional Patent Application, Serial No. 60/361,697, filed Mar. 6, 2002 by Sommers et al., and entitled “System Method and Computer Program Product for On-line Travel and Expense Management”, which is commonly assigned to the assignee of the present invention and incorporated herein by reference.

### FIELD OF THE INVENTION

The present invention relates generally to automating business processes, and more particularly to automating the procurement and control of travel itineraries, from pre-trip planning through post-trip accounting/auditing and posting of payment information to relevant disbursement systems.

### BACKGROUND OF THE INVENTION

The existing business process of setting up and accounting for travel for government or large commercial entities is labor intensive, paper oriented, and error prone.

FIGS. 1A and 1B show a typical work flow for arranging travel for government or large corporation travelers under conventional systems. When a traveler receives a travel assignment in step 102, the traveler initiates a travel authorization form (TAF) 110, based on mission requirements, in paper format or electronically, and contacts a travel agency to make reservations (step 104). The traveler can optionally obtain cost estimates required on the TAF 110 from the travel agency. While the traveler prepares the TAF 110 and submits it for approval to an approving official, such as a project manager in step 108, the travel agent checks for travel availability in the desired form, such as airline, train, or rental car, with an electronic database in step 106. Once authorized, the accounting department manually or electronically records an obligation in the accounting system in step 112. The traveler receives a copy of the authorized TAF 114 in step 116 and then contacts the travel agency, which confirms all reservations in step 118. Confirmation generates a charge to a traveler individually billed account (IBA) or centrally billed account (CBA) credit card or other method of payment in step 122. If charge is made to a CBA, a copy of the approved TAF 124 is forwarded to the travel agency to retain for CBA reconciliation in step 126. Confirmation also generates a traveler paper itinerary 128 and ticket (paper or electronic) that is forwarded to the traveler in step 120. Meanwhile, the traveler begins his travel, at step 130.

FIG. 1B continues the flowchart of FIG. 1A. If changes to the itinerary are needed during the travel period at decision 132, the traveler must contact the travel agency to arrange the changes in step 134, which may result in creation of an amendment 138 to the original TAF in step 136. If new travel arrangements result in new ticketing at decision step 140, a copy of the amended TAF 138 must be forwarded to the travel agency for use in future reconciliation in step 142. Upon returning from travel in step 144, the traveler must then fill out an expense report 148 to obtain reimbursement for allowable travel expenses, such as meals, hotels, parking, mileage, etc. in step 146. The expense report 148 must also be approved by an approver in step 150. Once approved, the expense report 154 is forwarded to the paying activity for computation of entitlements resulting in payment preparation in step 152. The traveler is then reimbursed at step 156.

The primary drawback of this flow is its inefficiency and high potential for inaccuracies and errors. The conventional process of arranging travel is labor intensive, and the number of different people and agencies involved often leads to miscommunication. Other drawbacks include an insufficient and incomplete paper trail, which can result in missing charges or other accounting problems, such as reflecting erroneous accounting data. The inefficiencies and the problems with the paper trail usually mean that the traveler receives reimbursements long after the charges were made. Additionally, the traveler is dependent upon support personnel, which can cause problems when the support personnel are not available.

What is needed then is an improved method and system that overcomes the inefficiencies of conventional solutions.

### SUMMARY OF THE INVENTION

In an exemplary embodiment of the present invention a system, method and computer program product for online travel arrangement is disclosed.

A preferred embodiment of the present invention covers changes in all facets of the government travel procurement business process, including pre-trip planning, pre-trip funding, automating trip booking and approval, automating post-trip expense reimbursement and reporting, approval and fund allocation.

The present invention meets the needs described above through the provision of a method in a computer system of arranging travel for large corporate and government organizations. A method according to an embodiment of the present invention may comprise receiving a customer login at an Internet web site; authenticating the customer; receiving a selection of travel requirements from the customer; making initial travel arrangements for the customer based on the selection of travel requirements; automatically generating a travel authorization form for the customer with the initial travel arrangements; electronically forwarding the travel authorization form to an approver; notifying the customer electronically when the approver has approved the travel authorization form; notifying a travel agency of approval of the travel authorization form whereupon the travel agency confirms the initial travel arrangements; and automatically updating an accounting system electronically for the customer.

Further features and advantages of the invention, as well as the structure and operation of various embodiments of the invention, are described in detail below with reference to the accompanying drawings.

### DEFINITIONS

The examples given below are not intended to be exhaustive, nor to limit the scope of the invention.

A “computer” refers to any apparatus that is capable of accepting a structured input, processing the structured input according to prescribed rules, and producing results of the processing as output. Examples of a computer include: a computer; a general-purpose computer; a supercomputer; a mainframe; a super mini-computer; a mini-computer; a workstation; a microcomputer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk such as a CD-ROM or a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links, including wireless links. Examples of a network include: an internet, such as the Internet; an intranet; a local area network (LAN); a wide area network (WAN); and a combination of networks, such as an internet and an intranet.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIGS. 1A-1B show a typical work flow for arranging government travel under conventional systems;

FIGS. 2A-2B show an exemplary embodiment of a work flow for arranging government travel according to the present invention; and

FIG. 3 depicts an exemplary embodiment of the system of the present invention.

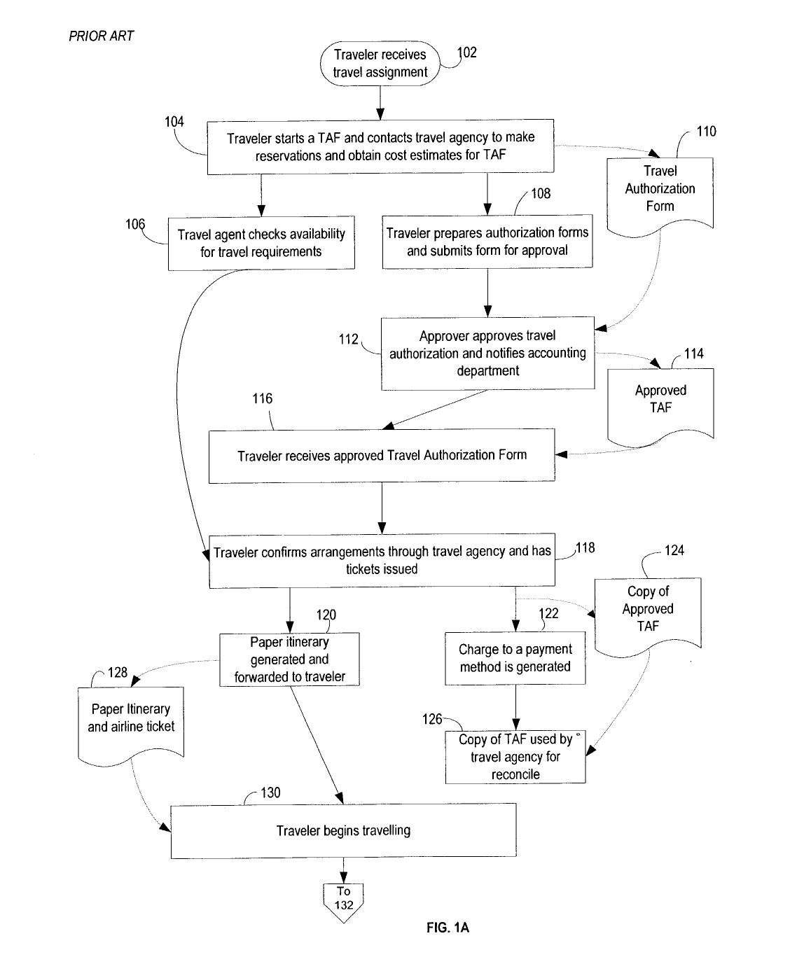

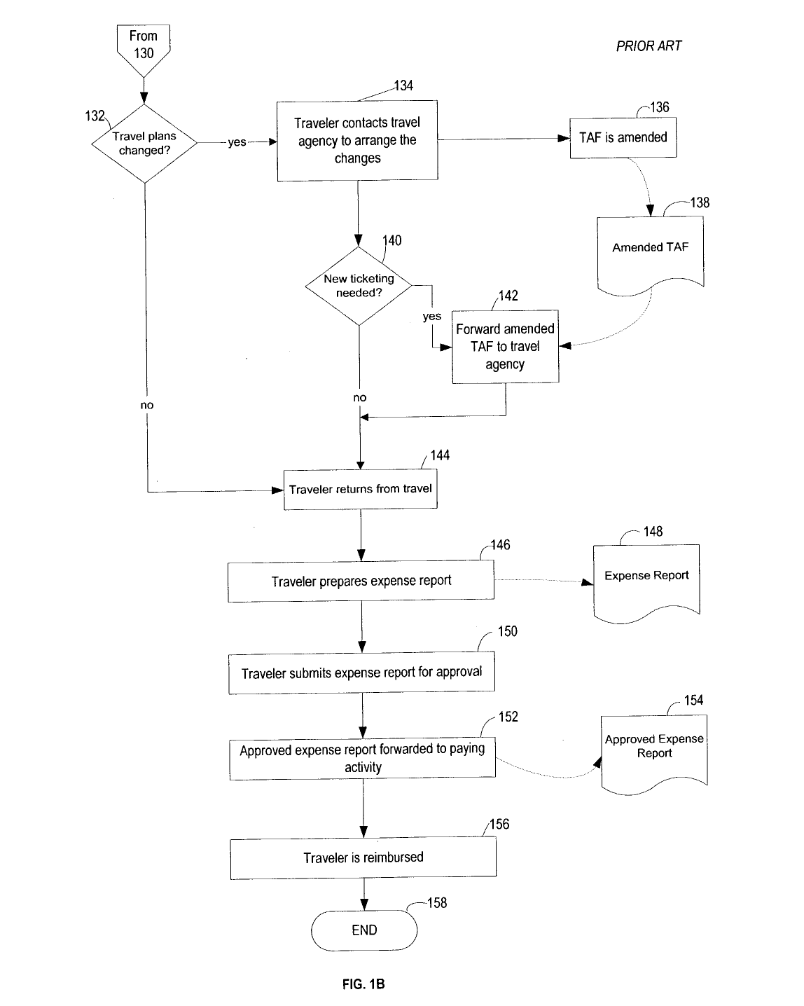

### DETAILED DESCRIPTION OF THE INVENTION

Preferred embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

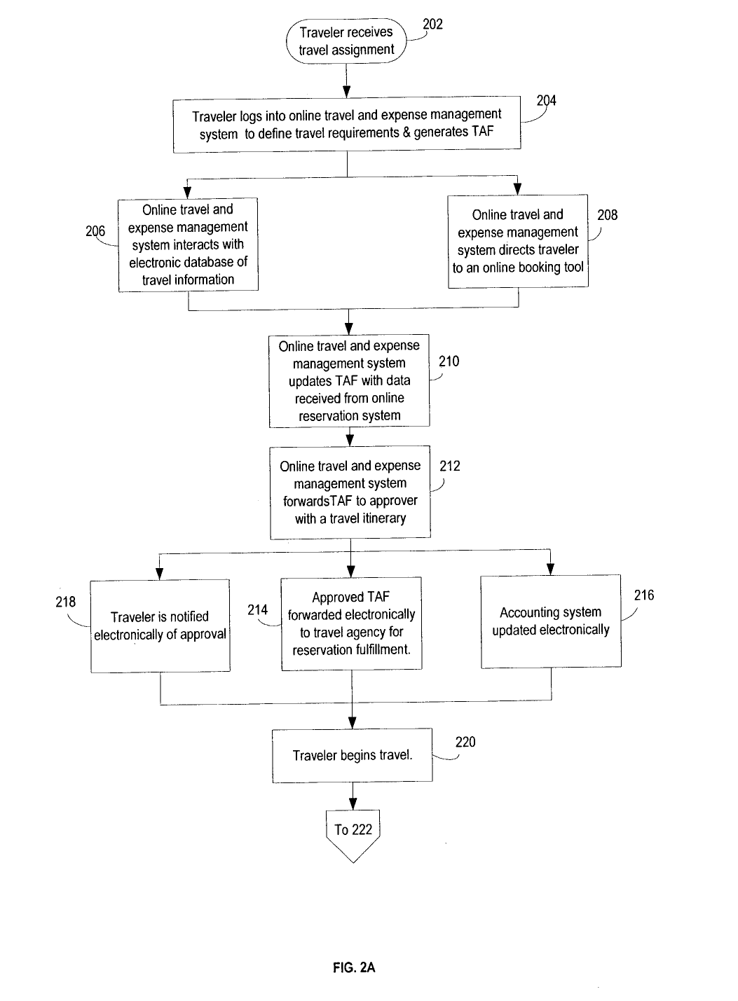

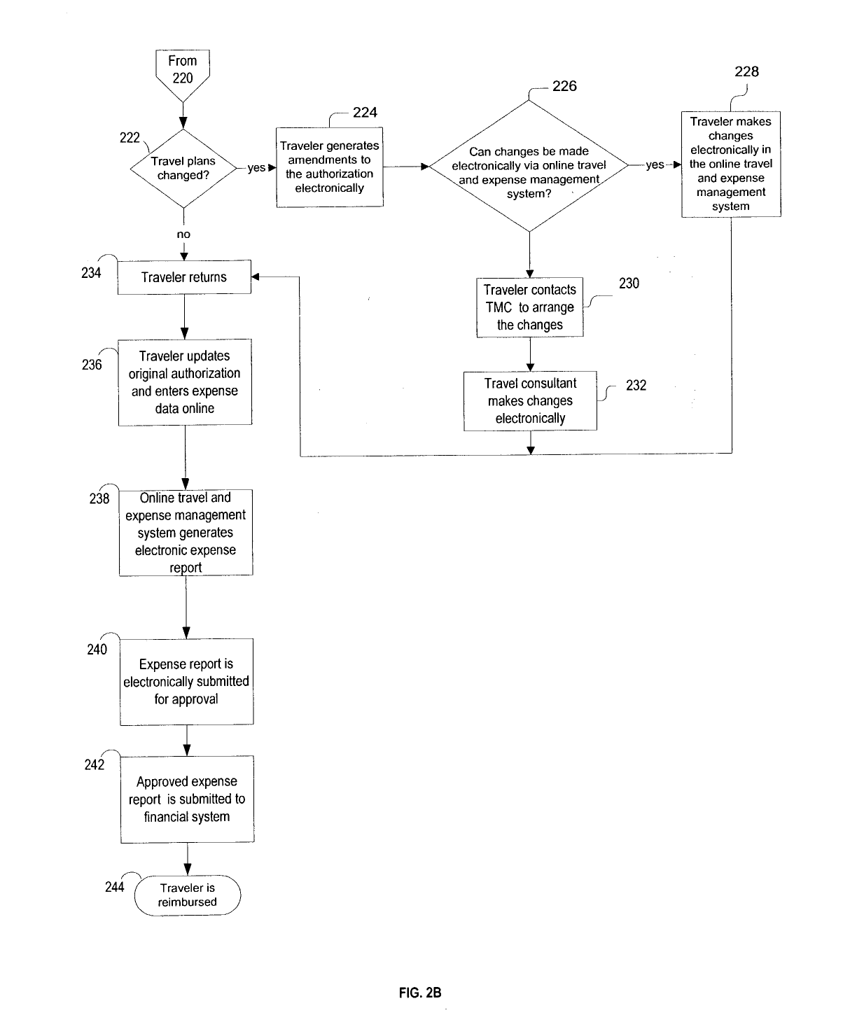

FIGS. 2A-2B show an exemplary embodiment of a workflow for arranging government travel or large commercial entity travel according to the present invention. A traveler receives a travel assignment in step 202 and logs onto the online Travel and Expense Management System (TEMS) of the present invention in step 204. When the user defines the travel requirements, the online TEMS generates a TAF in step 208. The online TEMS also interacts with an electronic database of travel information in step 206 and directs the traveler to an on-line booking tool in step 210. The online TEMS then updates the TAF with real-time cost estimates in step 212 and forwards the updated TAF, including a travel itinerary, to an approver for approval electronically in step 214. Following approval, any TAF approval information required for reconciliation is electronically forwarded to the Travel Management Center (TMC), which has access to the reservation system, as confirmation for ticketing in step 216. Additionally, accounting system updates are electronically routed for travel obligations in step 218. The traveler is notified electronically of the approval of TAF in step 220. The traveler then begins travel in step 222.

In FIG. 2B, if travel plans change at step 222, the traveler generates amendments to the approved travel authorization, step 224. If the changes can be made electronically via the online TEMS, step 226, the traveler makes the changes to the reservation electronically, step 228. Otherwise, the traveler can contact TMC to arrange needed changes, step 230, and a travel consultant makes changes in step 232. If no changes are needed, or when the travel has ended, the traveler returns in step 234. The traveler updates original travel authorization then enters travel expense data, such as, meals, fuel, and hotel costs, into the online TEMS in step 236. The online TEMS automatically generates an electronic expense report in step 238. The expense report is next submitted electronically to an approver for approval in step 240. Once approved, the expense report is submitted electronically to the disbursing system for processing in step 242. Finally the traveler is reimbursed in step 244. As illustrated, the process of arranging, changing, and approving travel and reimbursement proceeds entirely electronically. No papers need to be generated, reducing the possibility of lost forms. Using electronic data entry and transmittal greatly reduces the potential for human error in reporting expenses, which in turn reduces the time needed to correct errors. Travelers can also be reimbursed more quickly, and accounting data can be more up-to-date, due to the improved efficiency of the process.

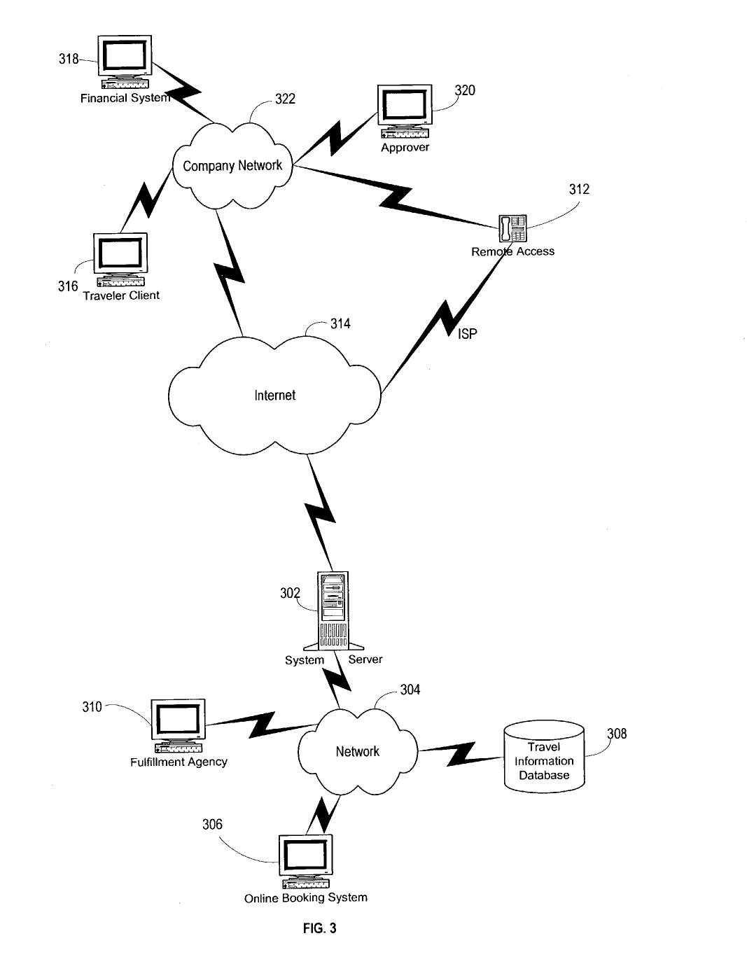

FIG. 3 illustrates an exemplary embodiment of the system of the present invention. The system is composed of the online TEMS server 302, which can be connected via a network 304 to one or more travel information databases 308 and to an online booking system 306. Fulfillment agency 310 may interface with one or more travel information databases 308. In addition, the system server 302 can provide remote access 312, for example, in the form of internet access via a network. The system server 302 can also be connected to an internet 314. The traveler can log into the system from a traveler client computer 316, which can be connected to a company network 322, which is in turn connected to the internet 314. The financial system 318 and the approver 320 are also connected to the company network 322.

In an exemplary embodiment, the present invention may comprise an automated online Travel and Expense Management System. The controls, parameters and regulatory requirements of the traveling organization can be configured at the client level. The present invention may provide the traveler with a means to generate travel authorizations, book travel arrangements on-line in real time, obtain approvals, submit actual expenses and receive reimbursement electronically. During the pre-travel authorization process, the present invention can allow customized multi-level approvers, provide “should cost” estimates, and flag exception data. During the post-travel reimbursement process, travelers can update original itineraries, input actual expenses and electronically route expense reports to appropriate approving officials. Following approval, expense reports are routed based upon customized audit parameters to on-line audit, flagging regulatory exceptions.

The present invention may be an Internet application using open connectivity and can allow password protected, multi-level user access, controlled by system administration. Regulatory guidance can be provided on-line along with reimbursement allowances. The present invention may provide optional payment to a travel charge card. Further, the present invention may automate interfaces performing funds validation, budget monitoring, obligation recording, and distribution payment data to customer financial systems.

One advantage of the above-described embodiment of the present invention is that it eliminates almost all investment on the part of the end-user, due to its use of existing Internet browser technology, and provides a superior tool for controlling travel expenditures through customized reporting, in accordance with several US Government regulations. In particular, the present invention can comply with Federal Travel Regulations (FTR), Joint Financial Management Improvement Program (JFMIP), Joint Travel Regulation (JTR), Joint Federal Travel Regulation (JFTR) and with US Government Request for Proposals (RFP), data access and retention, and pre-load traveler credit card data for validation. Further, the present invention can be made to comply with the travel policies and regulations of any commercial entity.

A system according to the present invention may comprise the following exemplary modules: system administration; traveler profile management; booking; travel in the continental United States (CONUS) and travel outside the continental United States (OCONUS); travel authorization; travel order authorization approval; expense report; travel expense report approval; local travel/miscellaneous expense; local travel/miscellaneous expense approval; audit; credit card debt management; and reports.

The system administration module may provide administration personnel the ability to define organizations, for example as major or minor customers, define organization business policies and parameters, add users and define their roles, and monitor and maintain the system database. The system administration module may also provide help desk personnel with a tool for assisting individual users in a prompt and efficient manner. The primary users of the system administration module may be developers and help desk personnel.

The traveler profile management module is primarily used to allow users to store general travel and secure payment information along with travel preferences that are used for the creation of a trip. The primary users of the traveler profile management module include all users of the system including, for example, the traveler, co-worker alternates, approvers, auditors, and credit card coordinators.

The primary purpose of the booking module may be to allow users to book their own reservations as defined in the travel authorization such as airline, car, and hotel reservations, for example. The booking module may, for example, be used primarily by travelers or designated co-workers inputting travel authorization requests.

The travel authorization module may be used primarily to provide users the ability to input specific travel requirements resulting in a travel authorization, create individual bookings, and track the status from initiation of request through approval. The primary users of the travel authorization module may include, for example, travelers or delegated co-workers inputting travel requirements and processing as a request for authorization to travel.

The travel order authorization approval module provides users defined as approvers the ability to approve, revise, or cancel travel authorizations. This module displays all pending travel authorizations to include departure date, order number, traveler name, destination, and status of order. The system may allow for various types and levels of approval. Users at different levels of approval may have access to or control over different aspects of the system. Primary users of the travel order authorization approval module may include users defined as approving officials regardless of type and level.

The expense report module may be used primarily to provide users the ability to file expense reports identifying actual expenses incurred. Expense reports are electronically routed through appropriate approval levels identified by the traveler's organization, and through audit to paying activity in order for disbursement to be processed. The primary users of the expense report module may include travelers or delegated co-workers inputting travel expense data.

The travel expense report approval module allows users defined as approvers to approve or revise expense reports. Once the traveler has completed travel and updated the expense report with valid travel expenses, dates, and modes of travel, the expense report is electronically forwarded to a designated approver for review. This system is the same for all levels of approval. The primary users of the travel expense report approval module may include, for example, users defined as approver regardless of level.

The primary purpose of the local travel/miscellaneous expense module may be to provide users a means to file for reimbursement for transportation expenses incurred conducting official business in the local area of their official duty station or for miscellaneous expenses incurred while conducting official business either on TDY or in the local area. Travelers or delegated co-workers inputting local travel expenses, for example, may be the primary users of the local travel/miscellaneous expense module.

The local travel/miscellaneous expense approval module may be primarily used, for example, to provide a user defined as a local travel approving official a means to approve or revise local travel expense reports. Once the traveler has completed travel and input expenses the local travel expense report is electronically forwarded to a designated approver for review. This system is the same for all levels of approval. The primary users of the local travel/miscellaneous expense approval module may be users defined as local travel approvers regardless of level.

The primary purpose of the audit module may be to provide a designated user the ability to audit approved vouchers both pre-payment and post-payment, identifying reason selected for audit as defined by established audit parameters. Primary users of the audit module may be designated auditors at a customer paying location, for example.

The credit card debt management module may be primarily used, for example, to provide an agency program coordinator (APC) the ability to monitor the day-to-day operations of the Government Travel Charge Card Program. Each APC maintains an up-to-date list of all current cardholders and accounts to include information such as account names, account numbers, addresses, and telephone numbers, for example. The credit card debt management module also allows the APC to suspend and/or cancel delinquent accounts and generate notifications to cardholders and their chain of command. The primary users of the credit card debt management module may be Government APC personnel designated by an activity commander or director.

The primary purpose of the reports module may be to provide users a tool to retrieve bits of information contained in data elements and display the data in a reportable format depending on the type of user (i.e., traveler, approver, customer manager, auditor, card coordinator, or system administrator, for example). The primary users of the reports module may include, for example, travelers, approvers, customer managers, auditors, card coordinators, and system administrators.

In another exemplary embodiment, the present invention is a new set of application software, system interfaces, and database technology that allows a complete end-to-end solution.

In another exemplary embodiment, the present invention can use the Internet as the delivery medium for all services, thus allowing for the adoption of the new technologies, such as, e.g. wireless technologies. Unlike current online Internet travel arrangement services which cannot interact directly with a user's accounting and approval infrastructure, the present invention can provide a complete end-to-end online Travel and Expense Management System to the user.

In an exemplary embodiment of the present invention, the interface between the on-line booking system and the invention can be implemented through an extensible markup language (XML) client software development kit (SDK) called the travel planner. The travel planner application generates XML files based on uniform resource locator (URL) queries sent to the electronic database of travel information.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method in a computer system of arranging travel for large corporate and government organizations comprising:
receiving a customer login at an Internet web site;
authenticating said customer;
receiving a selection of travel requirements from said customer;
making initial travel arrangements for said customer based on said selection of travel requirements;
automatically generating a travel authorization form for said customer with said initial travel arrangements;
electronically forwarding said travel authorization form to an approver;
notifying said customer electronically when said approver has approved said travel authorization form;
notifying a travel agency of approval of said travel authorization form whereupon said travel agency performs reservation fulfillment; and
automatically updating a financial system electronically for said customer.

2. The method according to claim 1, further comprising:
accepting expense data entered by said customer upon return from travel;
generating an electronic expense report from said customer input;
submitting said expense report for approval by an approver;
forwarding said expense report to said financial system for disbursement; and
reimbursing said customer for said expenses.

3. The method according to claim 1, further comprising:
changing travel plans using the system.

4. The method according to claim 1, wherein said step of making initial travel arrangements for said customer based on said selection of travel requirements comprises connecting said customer with an online travel booking tool.

5. A system for arranging travel for large corporate and government organizations, comprising:
a system server, comprising a computer connected to the Internet;
software operative to arrange travel running on said system server;
an online travel booking system connected to said system server via a first network;
a travel information database accessible from said system server via at least one of said first network and a second network;
at least one client computer connected to at least one of the Internet and a company network and capable of logging into said software operative to arrange travel; and
an electronic financial system connected to said company network.

6. A computer program product adapted to be stored on a computer-readable medium and being operable to arrange travel for large corporate and government organizations, the computer program product comprising:
a user interface for receiving a customer login and providing access to a system database;
a system administration module for providing administration personnel an ability to define at least one of organizations and organization business policies, add users and define roles of the users, and to monitor and maintain the system database;
a traveler profile management module for allowing the users to store at least one of general travel information of a traveler, secure payment information of a traveler, and travel preferences of a traveler on the system database;
a booking module for allowing the users to book reservations;
a travel authorization module for providing the user an ability to input specific travel requirements, through the user interface, resulting in a travel authorization, create individual bookings, and track a status of each order from initiation through approval; and
a travel order authorization approval module for providing an authorized user an ability to at least one of approve the travel authorization, revise the travel authorization, and cancel the travel authorization, wherein the travel order authorization approval module displays all pending travel authorizations including departure time, order number, traveler name, destination, and status of order.

7. The computer program product according to claim 6, further comprising:
an expense report module for providing at least one of a traveler and an authorized user an ability to file expense reports identifying expenses incurred and being electronically routed through appropriate levels of approval and through an audit module.

8. The computer program product according to claim 7, further comprising:
a travel expense report approval module for allowing an authorized user to at least one of approve the expense report and revise the expense report.

9. The computer program product according to claim 6, further comprising:
a local travel expense module for providing the traveler and other authorized users an ability to file a local travel expense report for reimbursement for expenses incurred while conducting official business within a predetermined local area.

10. The computer program product according to claim 9, further comprising:
a local travel expense approval module for providing an authorized approval official a means to at least one of approve the local travel expense report and revise the local travel expense report, wherein the local travel expense report is forwarded to the authorized approval official through electronic means.

11. The computer program product according to claim 7, further comprising:
an audit module for providing a designated user an ability to audit approved expense report, wherein the audit module allows the designated user to input a reason for selecting the expense report to be audited.

12. The computer program product according to claim 6, further comprising:
a credit card debt management module for providing the user an ability to moditor operations of the system database including at least one of an account name of the traveler, an account number of the traveler, an address of the traveler, and a telephone number of the traveler.

13. The computer program product according to claim 6, further comprising:
a reports module for providing the user a means to retrieve bits of information contained in data elements and to display the data in a reportable format.

14. The computer program product according to claim 6, wherein the booking module allows users to book at least one of an airline reservation, a car reservation, and a hotel reservation.
